(19) United States
(12) Patent Application Publication
(10) Pub. No.: US 2021/0086186 A1
(43) Pub. Date: Mar. 25, 2021

(54) A container and cooler arrangement

(71) Applicant: Instrunor AS, Bjørnemyr (NO)

(72) Inventors: Øystein Helge LJUNGMANN, Ski (NO); Torstein LJUNGMANN, Nesoddtangen (NO); John-Erik HASSEL, Nesoddtangen (NO)

(21) Appl. No.: 16/958,379

(22) PCT Filed: Dec. 19, 2018
(86) PCT No.: PCT/NO2018/050319

§ 371 Date: Jun. 26, 2020

(30) Foreign Application Priority Data
Dec. 29, 2017 (NO) 20172059

(51) Int. Cl. B01L 7/00; B01L 9/06

(52) U.S. Cl. CPC B01L 7/00; B01L 9/06; B01L 2300/045; B01L 2300/0809; B01L 2300/18; B01L 2200/025; B01L 2300/048

(57) ABSTRACT

A laboratory fluid receptacle cooler arrangement (10) for sustaining a desired temperature range, comprising a housing (16), a lid (32) covering an open top side of said housing (16), and an aperture closing element (11), wherein: the aperture closing element (11) at least partly covers said lid (32) and has a number of apertures (14). The lid also (32) comprises a number of apertures (44). The aperture closing element (11) is movable relative to the lid between open and closed positions, the aperture closing element and the lid having matching aperture configuration, thereby providing throughholes when the aperture closing element and the lid are in open configuration. Also, a cooler closure arrangement (30) with an aperture closing element (11) on top of a lid (32) where the aperture closing element (11) and the lid (32) are parallel and substantially plane rectangles in slideable engagement with each other.

### TECHNICAL FIELD

The present invention belongs to the field of laboratory work and relates to the cooling of laboratory fluids and maintenance of a cooling temperature for laboratory fluids, in particular it is disclosed a laboratory fluid receptacle cooler arrangement 10 with an aperture closing element 11 for the cooling of laboratory fluids.

### BACKGROUND ART

In hospitals and laboratories, there is a need for maintaining laboratory fluids under stable conditions during storage and utilisation. This can be achieved through controlling a plurality of environmental factors. However, it can be difficult to maintain control of the plurality of environmental factors. Lack of control may contribute towards deterioration of laboratory fluids and reduction of their shelf life, which may result in erroneous test results.

One object of the present invention is to overcome the problems with deterioration of laboratory fluids.

### SUMMARY OF THE INVENTION

In one aspect, the present invention comprises a laboratory fluid receptacle cooler arrangement for sustaining a desired temperature range therein, comprising a housing, a lid covering an open top side of said housing, and an aperture closing element. Said aperture closing element at least partly covers said lid. Said aperture closing element has a number of apertures. Said lid has a number of apertures. Said aperture closing element is movable relative to the lid between an open and a closed position. The aperture closing-element and the lid has matching aperture configuration, thereby providing through holes when the aperture closing element and the lid are in an open configuration. The aperture closing-element facilitates sustaining a desired temperature range within said laboratory fluid receptacle cooler arrangement and it also ensure a more controlled and stable microclimate inside the receptacle cooler arrangement.

Said aperture closing element (11) has the same number of apertures (14) as the number of apertures (44) of said lid (32). Said housing contains at least one storage means having a number of spaces for storing a plurality of laboratory fluid receptacles. At least one aperture of said aperture closing element is vertically aligned with at least one storage means space when said aperture closing element is in the open position. The number of apertures of the aperture closing element is equal to or greater than the number of spaces for storing the laboratory fluid receptacles in the at least one storage means. The storage means spaces are accessible through the apertures when the aperture closing-element is in the open position. The storage means spaces are inaccessible when the aperture closing-element is in the closed position. Said aperture closing element comprises at least one engagement element for moving the aperture closing-element. Said aperture closing element and said lid are connected by at least one, preferably two guide slits and at least one, preferably two bolts, wherein each bolt is slotted into a different guide slit. Said guide slits have a length x. Said aperture closing element and said lid are plane. Said lid has at least one male guide fitment element. Said housing has at least one female guide indent on the top of at least one side of the housing. Each male guide fitment element slots into a different female guide indent when said lid covers the open top side of said housing, whereby said lid is maintained within its position when said aperture closing element is moving. Said aperture closing element and said lid are removable from said housing either separately or together. Said apertures are adapted for a needle to come therethrough.

In another aspect, the present invention comprises a cooler closure arrangement with an aperture closing-element on top of a lid. The aperture closing-element and the lid are parallel and substantially plane rectangles in slidable engagement with each other. The aperture closing-element has a number of apertures. Said lid has a number of apertures. Said aperture closing-element is movable relative to the lid between an open and a closed position. The aperture closing-element and the lid has matching aperture configuration, thereby providing through holes when the aperture closing-element and the lid are in an open configuration.

Said aperture closing-element comprises at least one engagement element for moving the aperture closing-element. Said aperture closing-element and said lid are connected by at least one, preferably two guide slits and at least one, preferably two bolts. Each bolt is slotted into a different guide slit.

Other advantageous embodiments, aspects and details according to the present invention will become apparent by the accompanying claims.

### BRIEF DESCRIPTION OF THE DRAWINGS

In order to make the invention more readily understandable, the discussion that follows will refer to the accompanying drawings, in which:

FIG. 1 shows an assembled laboratory fluid receptacle cooler arrangement;

FIG. 2 shows different storage means 21, 22, 23, 24 for storing laboratory fluid receptacles inside the housing 16;

FIG. 3A shows the aperture closing element 11 on top of lid 32, wherein the aperture closing element 11 is in a closed position after being slid a distance X1 to the right relative to an open position;

FIG. 3B shows the aperture closing element 11 on top of lid 32, wherein the aperture closing element 11 is in an open position after being slid a distance X1 to the left relative to the closed position;

FIG. 4A shows the aperture closing element 11 and lid 32 assembled in a closed position seen in a perspective from above;

FIG. 4B shows the aperture closing element 11 and lid 32 assembled in a closed position seen in a perspective from below; and

FIG. 5 shows a configuration of a storage means 21 comprising two plates 54, 55 having storage means spaces 51 connected by distance sleeves 52 and fastening means 53, and handle element 25A.

### DETAILED DESCRIPTION OF THE INVENTION

In the following, the present invention will be discussed by describing preferred embodiments, and by referring to the accompanying drawings. However, people skilled in the art will realise other applications and modifications within the scope of the invention as defined in the enclosed independent claims.

In hospitals and laboratories, there is a need for maintaining laboratory fluids under stable conditions during storage and utilisation. This can be achieved through controlling a plurality of environmental factors. However, it can be difficult to maintain control of the plurality of environmental factors. Lack of control may contribute towards deterioration of laboratory fluids and reduction of their shelf life, which may result in erroneous test results.

One object of the present invention is to provide an arrangement for temperature control of laboratory fluids more generally to improve control of microclimate for laboratory fluids.

A basic idea behind the present invention is to provide a receptacle cooler arrangement with access to laboratory fluid receptacles, which greatly reduces heat transfer between cooler receptacle interior and environment.

In a general embodiment this is achieved by providing a cooler closure arrangement with two plate lids on top of each other movable relative to each other and where the top lid and the lid below has matching aperture configuration, thereby providing through holes when the lids are in an open configuration. The through holes have significantly reduced exposure area to the environment compared with traditional “one lid” closure arrangements where the lid is removed from the receptacle cooler arrangement to give access to the laboratory fluid receptacles inside the receptacle cooler thereby exposing the full interior of the receptacle cooler.

The use of a cooler closure arrangement does not only ensure reduced heat transfer between interior of the cooler and the environment, it also ensures a generally more stable microclimate inside of the cooler arrangement. By using the cooler closure arrangement, the atmosphere in the micro environment is improved and oxidation in antibody tubes will decrease because of air supply and condensation being reduced. An additional benefit is that dilution of antibody located down in the tubes is reduced. This gives a longer lifespan on sensitive antibody and antibody cocktails.

In one aspect, the present invention comprises a laboratory fluid receptacle cooler arrangement 10 for sustaining a desired temperature range therein, comprising a housing 16, a lid 32 covering an open top side of said housing 16, and an aperture closing element 11.

The housing 16 has four walls and a bottom plate connected to the bottom of the four walls, where opposite walls are parallel

Said aperture closing element 11 at least partly covers said lid 32. Said aperture closing element 11 has a number of apertures 14. Said lid 32 has a number of apertures 44. Said aperture closing element 11 is movable relative to the lid between an open and a closed position. The aperture closing-element and the lid has matching aperture configuration, thereby providing through holes when the aperture closing-element and the lid are in an open configuration. The apertures 14 of said aperture closing element 11 can be in line with the apertures 44 of the lid 32 when said aperture closing-element 11 is in the open position. The apertures 44 of the lid 32 can be covered by said aperture closing element 11 when said aperture closing-element 11 is in the closed position.

Said aperture closing-element 11 can have the same number of apertures 14 as the number of apertures 44 of said lid 32. This can be in a matching configuration. Said aperture closing-element 11 can have the same pattern of apertures 14 as the pattern of apertures 44 of said lid 32.

The aperture closing-element 11 facilitates sustaining a desired temperature range within said laboratory fluid receptacle cooler arrangement 10 and in general, it provides a more stable microclimate within the laboratory fluid receptacle cooler arrangement. The desired temperature range within the laboratory fluid receptacle cooler arrangement 10 can be from 0.1° C. to 15° C., from 1° C. to 12° C., or from 2° C. to 8° C. The laboratory fluid receptacle cooler arrangement 10 may comprise a cooling means comprising at least one inlet circulation fan and at least one outlet circulation fan. The cooling means can further comprise a heat sink with one or more Peltier elements or heat sink elements.

Said housing 16 contains at least one storage means 21, 22, 23, 24 having a number of spaces 51 for storing a plurality of laboratory fluid receptacles. In addition, at least one of said storage means 21, 22, 23, 24 may be removable in order to be changed with another storage means 21, 22, 23, 24 having different arrangements and placements of spaces 51 for laboratory fluid receptacles. The storage means 21, 22, 23, 24 may have handle elements 25A, 25B, 26 to ease the handling of the storage means 21, 22, 23, 24 when moving said storage means 21, 22, 23, 24. The storage means may be composed of several plates 54, 55 connected by at least one distance sleeve 52 and at least one fastening means 53. The fastenings means 53 can be a screw, bolt etc. The storage means 21, 22, 23, 24 are designed for storing a plurality of laboratory fluid receptacles, each storage means 21, 22, 23, 24 may be designed to store a different number of laboratory fluid receptacles. The laboratory fluid receptacles may be of any size fitting into the storage means space 51 of the storage means 21, 22, 23, 24, or if not fitting in the storage means 21, 22, 23, 24, fitting inside said laboratory fluid receptacle cooler arrangement 10. The laboratory fluid receptacles may be of different shapes and sizes, accommodated according to the type and volume of fluid they store. A laboratory fluid receptacle may be a vial, tube, container, or similarly thereof for storing laboratory fluids. The laboratory fluid may be any fluid suitable for laboratory use, such as, but not limited to, reagents, diluents, antibody suspension, ready mixed cocktail, or variations thereof.

At least one aperture 14 of said aperture closing element 11 is vertically aligned with at least one storage means space 51 when said aperture closing element 11 is in the open position. The number of apertures 14 of the aperture closing element 11 is equal to or greater than the number of spaces 51 for storing the laboratory fluid receptacles in the at least one storage means 21, 22, 23, 24. This allows accessibility to all the storage means spaces 51 such that the content of the laboratory fluid receptacles when inserted into the storage means spaces 51 is accessible. The storage means spaces 51 are accessible through the apertures 14, 44 when the aperture closing-element 11 is in the open position. This allows withdrawal of fluid from the laboratory fluid receptacles. The storage means spaces 51 are inaccessible when the aperture closing-element 11 is in the closed position.

Said aperture closing element 11 comprises at least one engagement element 12 for moving the aperture closing-element 11. Said engagement element 12 may be pushed, pulled, hooked or gripped for moving said aperture closing-element 11. The moving of the aperture closing-element 11 can be manual or automatic. If automatic, a robot arrangement comprising at least one arm arrangement may exert force on the protrusion to move the aperture closing-element 11 in either direction. An operating computer comprising at least one central processing unit (CPU) may be configured to control the robot arrangement for achieving automation of the opening and closing procedures of the aperture closing-element 11.

Said aperture closing-element 11 and said lid 32 are connected by at least one, preferably two guide slits 45A, 45B and at least one, preferably two bolts 46A, 46B, wherein each bolt 46A, 46B is slotted into a different guide slit.

The aperture closing-element 11 may be provided with the guide slits 45A, 45B and the lid 32 may be provided with the bolts 46A, 46B.

FIGS. 4A and 4b shows the lid 32 with the guide slits 45A, 45B and the aperture closing-element 11 with the bolts 46A, 46B.

In a different configuration, the lid 32 may be provided with guide slits 45A, 45B and bolts 46A, 46B and the aperture closing-element 11 may be provided with guide slits 45A, 45B and bolts 46A, 46B.

The guide slits 45A, 45B and bolts 46A, 46B allow the aperture closing-element 11 and the lid 32 to be fitted together in a particular configuration when the bolts 46A, 46B are slotted into the guide slits 45A, 45B. Preferably, the aperture closing-element 11 and lid 32 are aligned on top of each other. The apertures 14 of the aperture closing-element 11 and the apertures 44 of the lid 32 are thereby axially aligned allowing a passage through them when the aperture closing-element 11 is in the open position.

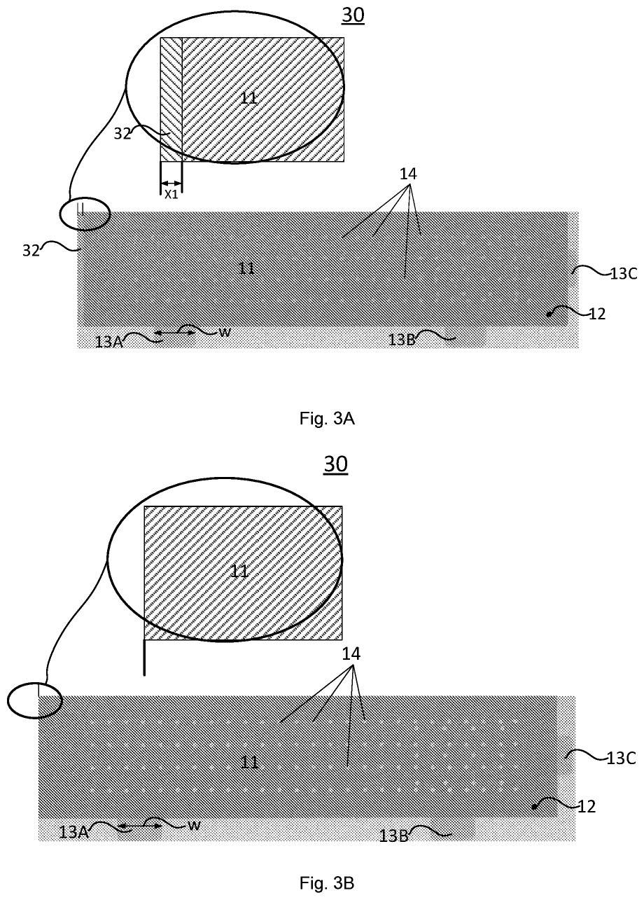

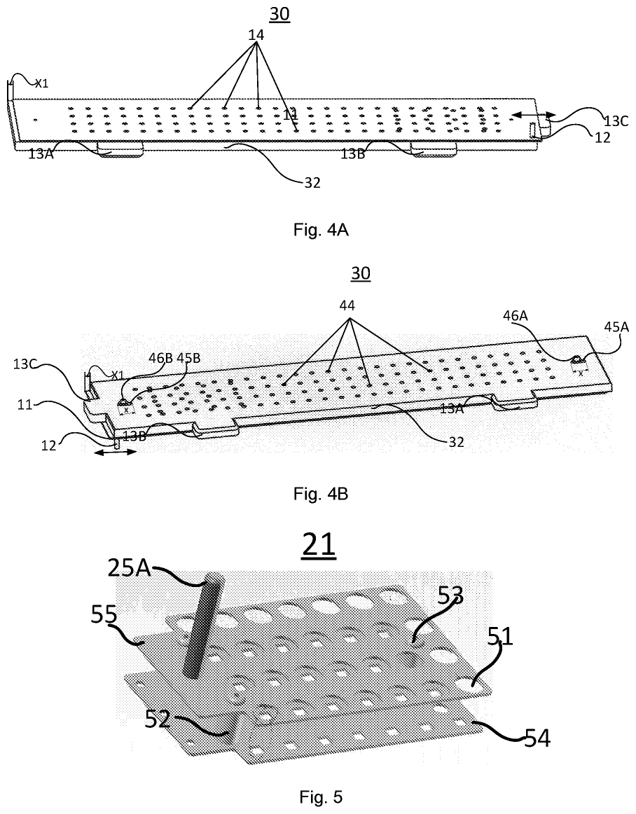

Said guide slits 45A, 45B can have a length x. Preferably the guide slits 45A, 45B are elongated with a length x. The length x determines the travelling distance the aperture closing element 11 can move along the lid 32 indicated as a distance X1 in FIG. 3A and FIG. 3B. Preferably, the distance is such that at one end of the distance, the aperture closing-element 11 is in the open position and at another end of the distance, the aperture closing-element 11 is in the closed position. Length x may be up to 15 mm, 10 mm, 7 mm, or 5 mm long.

The direction of the guide slits 45A, 45B determines the direction the aperture closing-element 11 can move relative to the lid 32. The aperture closing element 11 may move along the lid 32 guided by the direction and length of the guide slits 45A, 45B. The aperture closing element 11 may move across the lid 32 guided by the direction and length of the guide slits 45A, 45B.

Said aperture closing element 11 and said lid 32 are plane. Said lid 32 can include at least one male guide fitment element 13A, 13B, 13C, and said housing 16 can be provided with a matching number of female guide indent 15A, 15B, 15C on the top of at least one wall of the housing 16. The female guide indent 15A, 15B, 15C is designed to receive the male guide fitment element 13A, 13B, 13C thereby providing a fixture between lid 32 and the housing 16 which is maintained even when the aperture closing element 11 is moved relative to the lid 32. More than one wall of the housing 16 can have at least one female guide indent 15A, 15B, 15C on the top. The walls of the housing 16 can be provided with a different number of female guide indents 15A, 15B, 15C. For instance, one wall may have one female guide indent 15A, 15B, 15C and another wall may have two female guide indents 15A, 15B, 15C as shown in FIG. 3A-4B. The female guide indents 15A, 15B, 15C can have same depth d. The female guide indents 15A, 15B, 15C may have different width w or they may have the same width w. The male guide fitment element 13A, 13B, 13C is arranged on the side edges of the lid 32. The male guide fitment elements 13A, 13B, 13C are plane. More than one side edge of the lid 32 can have at least one male guide fitment element 13A, 13B, 13C. The number of male guide fitment element 13A, 13B, 13C is a design matter. In FIGS. 4A and 4B one long side is provided with two male guide fitment elements and one short side is provided with one male guide fitment element the two other sides does not include any male guide fitment elements. The width of the male guide fitment elements 13A, 13B, 13C is a matter of design. Each female guide indent 15A, 15B, 15C has a corresponding male guide fitment element 13A, 13B, 13C, preferably in a configuration where the lid 32 has only one option of how to be arranged to cover the open top wall of said housing 16. When the lid 32 covers the open top side of said housing 16, the apertures of the lid 32 are aligned with the storage means spaces 51 for allowing access. An aperture 44 provides access to up to one storage means space 51.

Said aperture closing element 11 and said lid 32 are removable from said housing 16 either separately or together.

Said apertures 14, 44 can be adapted to receive a needle there through or the apertures 14, 44 can be adapted to receive a pipette. The size and shape of the apertures is a matter of design and it is dictated by the intended use, i.e. what shall be accessed from the interior of the receptacle cooler arrangement 10.

It is also possible to just have a cooler closure arrangement (30) with an aperture closing element (11) on top of a lid (32), the aperture closing element (11) and the lid (32) are parallel and substantially plane rectangles in slidable engagement with each other. The aperture closing-element (11) has a number of apertures (14). Said lid (32) has a number of apertures (44). Said aperture closing element (11) is movable relative to the lid between an open and a closed position. The aperture closing-element and the lid has matching aperture configuration, thereby providing through holes when the aperture closing-element and the lid are in an open configuration.

Said aperture closing element (11) comprises at least one engagement element (12) for moving the aperture closing-element (11). Said aperture closing element (11) and said lid (32) are connected by at least one, preferably two guide slits (45A, 45B) and at least one, preferably two bolts (46A, 46B). Each bolt (46A, 46B) is slotted into a different guide slit (45A, 45B).

When the aperture closing-element 11 is in the closed position, the interior of the laboratory fluid receptacle cooler arrangement 10 is less exposed to the formation of moisture and subsequent condensation. If the laboratory fluids stored in laboratory fluid receptacles are subject to condensation, the concentration of non-condensed laboratory fluid may become altered, which introduces errors into laboratory or clinical experiments, tests and/or protocols. Furthermore, there will be fewer and smaller temperature fluctuations and there can be a more even temperature distribution within the laboratory fluid receptacle cooler arrangement 10. It is therefore more convenient to achieve and sustain a desired temperature range for storing the laboratory fluids. Storage above the desired temperature range may cause degradation of the laboratory fluids, such as through proteolytic degradation, oxidation and undesired microbial growth. Such storage shortens the shelf life of laboratory fluids. If the laboratory fluids are not stored correctly, they may affect the outcome of laboratory or clinical experiments, tests and/or protocols and could potentially cause erroneous results. The consequences could be wrong conclusions and/or having to redo said laboratory or clinical experiments, tests and/or protocols, which in turn takes extra time, increases cost, and may cause delays.

When the aperture closing-element 11 is in the closed position, light is prevented from entering the laboratory fluid receptacle cooler arrangement 10. Laboratory fluids may comprise components that increase the photosensitivity of said laboratory fluids, such as detergents, and there is thus a need to reduce the light exposure of said laboratory fluids to avoid. Some laboratory fluids contain fluorescence-conjugates, such as fluorescent-conjugated antibodies. Such conjugates are to be kept away from light as light exposure causes photobleaching of said fluorescent conjugate. If such laboratory fluids are not stored correctly and consequently subjected to unnecessary light exposure, said laboratory fluids may affect the outcome of laboratory or clinical experiments, tests and/or protocols and could potentially cause erroneous results. The consequences could be wrong conclusions and/or having to redo said laboratory or clinical experiments, tests and/or protocols, which in turn takes extra time, increases cost, and may cause delays.

### Examples

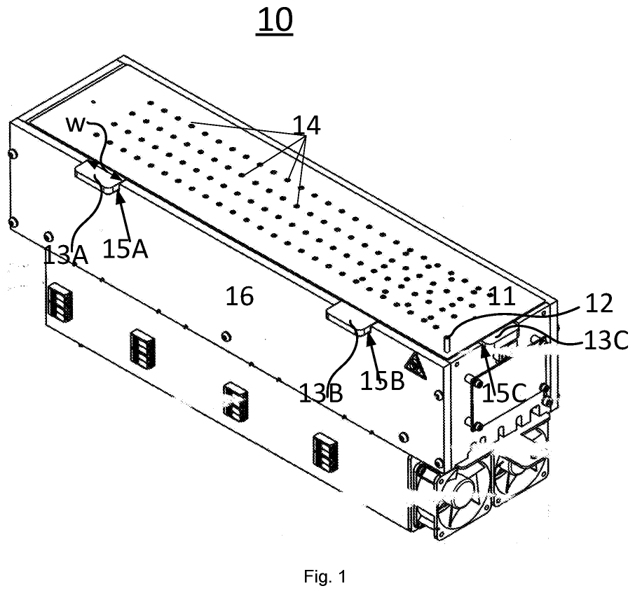

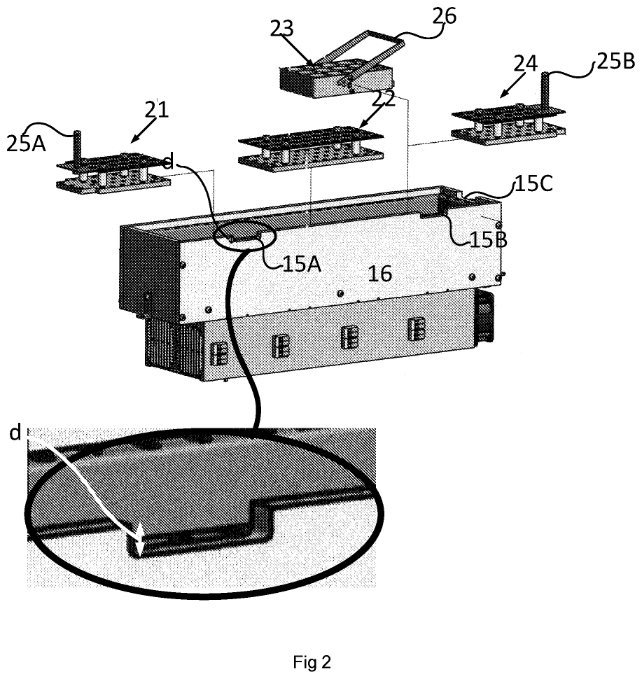

In one example, as seen in FIG. 1, the lid 32 and aperture closing element 11 are rectangular, said housing 16 is also rectangular in shape. The housing 16 has two female guide indents 15A, 15B along a long side and one female guide indent 15C on a short side. The lid 32 has three male guide fitment elements 13A, 13B, 13C: two male guide fitment elements 13A, 13B along a long side and one male guide fitment element 13C along a short side. When fitting the lid into the open top side of the housing 16, male guide fitment element 13A fits into female guide indent 15A, male guide fitment element 13B fits into female guide indent 15B and male guide fitment element 13C fits into female guide indent 15C. The lid 32 has two guide slits 45A, 45B and the aperture closing element 11 has two bolts 46A, 46B, wherein each bolt 46A, 46B is slotted into a guide slit 45A, 45B such that there is one bolt 46A, 46B for each guide slit. The direction and length of said guide slits 45A, 45B determine the direction and distance X1 of movement of said aperture closing element 11. The length of the slits is such that when the aperture closing element 11, directed by the bolts 46A, 46B slotted into the guide slits 45A, 45B, has moved from an end position to another end position, it has moved from an open to a closed state or from a closed to an open state by a distance of X1 mm.

Reference list

| | |
|---|---|
| 10 | Laboratory fluid receptacle cooler arrangement |
| 11 | Aperture closing element |
| 12 | Engagement element |
| 13A | Male guide fitment element |
| 13B | Male guide fitment element |
| 13C | Male guide fitment element |
| 14 | Aperture |
| 15A | Female guide indent |
| 15B | Female guide indent |
| 15C | Female guide indent |
| 16 | Housing |
| 21 | Storage means |
| 22 | Storage means |
| 23 | Storage means |
| 24 | Storage means |
| 25A | Handle element |
| 25B | Handle element |
| 26 | Handle element |
| 30 | Cooler closure arrangement comprising lid 32 and aperture closing |
| | element 11 |
| 32 | Lid |
| 44 | Aperture |
| 45A | Guide slit |
| 45B | Guide slit |
| 46A | Bolt |
| 46B | Bolt |
| 51 | Storage means space |
| 52 | Distance sleeve |
| 53 | Fastening means, screw, bolt etc. |
| 54 | Plate |
| 55 | Plate |
| X1 | Moving linear distance between aperture closing element and lid |
| X | Length of guide slit 45A, 45B |
| d | Depth of male guide fitment element |
| w | Width of male guide fitment element |

1. A laboratory fluid receptacle cooler arrangement (10) for improved microclimate control therein, comprising a housing (16), a lid (32) covering an open top side of said housing (16), and an aperture closing element (11), wherein:
said aperture closing element (11) at least partly covers said lid (32),
said aperture closing element (11) has a number of apertures (14),
said lid (32) has a number of apertures (44),
said aperture closing element (11) is movable relative to the lid between an open and a closed position, and
the aperture closing element and the lid has matching aperture configuration, thereby providing through holes when the aperture closing element and the lid are in an open configuration, whereby the aperture closing element (11) facilitates sustaining a desired temperature range within said laboratory fluid receptacle cooler arrangement (10).

2. A laboratory fluid receptacle cooler arrangement (10) according to claim 1, wherein said aperture closing element (11) has the same number of apertures (14) as the number of apertures (44) of said lid (32).

3. A laboratory fluid receptacle cooler arrangement (10) according to claim 1, comprising:
said housing (16) contains at least one storage means (21, 22, 23, 24) having a number of spaces (51) for storing a plurality of laboratory fluid receptacles,
at least one aperture (14) of said aperture closing element (11) is vertically aligned with at least one storage means space (51) when said aperture closing element (11) is in the open position, and
the number of apertures (14) of the aperture closing element (11) is equal to or greater than the number of spaces (51) for storing the laboratory fluid receptacles in the at least one storage means (21, 22, 23, 24),
whereby the storage means spaces (51) are accessible through the apertures (14, 44) when the aperture closing-element (11) is in the open position and are inaccessible when the aperture closing-element (11) is in the closed position.

4. A laboratory fluid receptacle cooler arrangement (10) according to claim 1, wherein said aperture closing element (11) comprises at least one engagement element (12) for moving the aperture closing element (11).

5. A laboratory fluid receptacle cooler arrangement (10) according to claim 1, wherein said aperture closing element (11) and said lid (32) are connected by at least one, preferably two guide slits (45A, 45B) and at least one, preferably two bolts (46A, 46B), wherein each bolt (46A, 46B) is slotted into a different guide slit (45A, 45B).

6. A laboratory fluid receptacle cooler arrangement (10) according to claim 4, wherein said guide slits (45A, 45B) have a length x.

7. A laboratory fluid receptacle cooler arrangement (10) according to claim 1, wherein said aperture closing element (11) and said lid (32) are plane.

8. A laboratory fluid receptacle cooler arrangement (10) according to claim 1, wherein said lid (32) has at least one male guide fitment element (13A, 13B, 13C).

9. A laboratory fluid receptacle cooler arrangement (10) according to claim 7, wherein said housing (16) has at least one female guide indent (15A, 15B, 15C) on the top of at least one side of the housing (16).

10. A laboratory fluid receptacle cooler arrangement (10) according to claim 7, wherein each male guide fitment element (13A, 13B, 13C) slots into a different female guide indent (15A, 15B, 15C) when said lid (32) covers the open top side of said housing (16), whereby said lid (32) is maintained within its position when said aperture closing element (11) is moving.

11. A laboratory fluid receptacle cooler arrangement (10) according to claim 9, wherein said aperture closing element (11) and said lid (32) are removable from said housing (16) either separately or together.

12. A laboratory fluid receptacle cooler arrangement (10) according to claim 1, wherein said apertures (14, 44) are adapted for a needle to come there through.

13. A cooler closure arrangement (30) with an aperture closing element (11) on top of a lid (32), the aperture closing element (11) and the lid (32) are parallel and substantially plane rectangles in slideable engagement with each other,
the aperture closing-element (11) has a number of apertures (14),
said lid (32) has a number of apertures (44),
said aperture closing element (11) is movable relative to the lid between an open and a closed position,
the aperture closing element and the lid has matching aperture configuration, thereby providing through holes when the aperture closing element and the lid are in an open configuration.

14. A cooler closure arrangement (30) according to claim 13, wherein said aperture closing element (11) comprises at least one engagement element (12) for moving the aperture closing-element (11).

15. A cooler closure arrangement (30) according to claim 13, wherein said aperture closing element (11) and said lid (32) are connected by at least one, preferably two guide slits (45A, 45B) and at least one, preferably two bolts (46A, 46B), wherein each bolt (46A, 46B) is slotted into a different guide slit (45A, 45B).
